(19) United States
(12) Patent Application Publication
(10) Pub. No.: US 2013/0335550 A1
(43) Pub. Date: Dec. 19, 2013

(54) INFRARED SENSOR SYSTEMS AND METHODS

(71) Applicant: FLIR Systems, Inc., Wilsonville, OR (US)

(72) Inventors: Thomas W. Rochenski, Haverhill, MA (US); Thomas J. Scanion, Hampstead, NH (US); Nicholas Hogasten, Santa Barbara, CA (US); Mary L. Deal, Santa Maria, CA (US); Arthur J. McGowan, JR., Tualatin, OR (US); Jeffrey D. Frank, Santa Barbara, CA (US); Andrew C. Teich, West Linn, OR (US)

(73) Assignee: FLIR Systems, Inc., Wilsonville, OR (US)

(21) Appl. No.: 13/973,968

(22) Filed: Aug. 22, 2013

Related U.S. Application Data
(63) Continuation of application No. PCT/US2012/025697, filed on Feb. 17, 2012.
(60) Provisional application No. 61/445,280, filed on Feb. 22, 2011.

(51) Int. Cl. H04N 5/33; G06T 7/00

(52) U.S. Cl. CPC H04N 5/33; G06T 7/00
USPC 348/82; 382/100

(57) ABSTRACT

Infrared imaging systems and methods disclosed herein, in accordance with one or more embodiments, provide for a wireless thermal imaging system comprising one or more wireless thermal image sensors adapted to capture and provide thermal images of structural objects of a structure for monitoring moisture of the structural objects and a processing component adapted to receive the thermal images of the structural objects from the one or more wireless thermal image sensors, and process the thermal images of the structural objects to generate moisture content information for remote analysis of restoration conditions of the structural objects.

### CROSS REFERENCE TO RELATED APPLICATIONS

This application is a continuation of International Patent Application No. PCT/US2012/025697 filed Feb. 17, 2012, which claims priority to U.S. Provisional Patent Application No. 61/445,280 filed Feb. 22, 2011, which are both incorporated herein by reference in their entirety.

### TECHNICAL FIELD

The present disclosure relates to infrared imaging systems and, in particular, to infrared sensor systems and methods.

### BACKGROUND

When a building is compromised, such as in the event of an emergency (e.g., an earthquake, explosion, terrorist attack, flood, fire, other type of disaster, etc.), government agencies typically seek to gain knowledge as to the status of the damage and to the number of persons present in the building (e.g., any type of structure or defined perimeter). Surveillance cameras may be utilized to discover this knowledge. Surveillance cameras typically utilize color and monochrome imagers that are sensitive to ambient light in the visible spectrum. Unfortunately, visible light cameras are not ideally suited for detecting persons, including persons in need of assistance. For example, visible light cameras typically produce inferior quality images in low light conditions, such as when interior lighting is not operating in the event of power outage or failure. Generally, loss of power may be expected in disastrous situations that may require emergency aid for persons inside the building.

As such, in the event of an emergency with potential loss of power, it may be critical for search and rescue personnel to quickly and easily locate persons in the building. Conventional visible light cameras generally do not operate in total or near total darkness, such as night time or during a power outage, or provide information as to moisture levels for a structural member of a building. Conventional security cameras may not operate autonomously. In the event of total or partial collapse of a building, a conventional visible light camera may not withstand a high impact, and locating the camera in a collapsed building may be difficult to retrieve.

Even in non-emergency conditions, it may be important to quickly and easily identify and alert personnel if, for example, a person has fallen or is in a location they should not be or needs some kind of assistance.

Accordingly, there is a need for an improved imaging device that may be used for a variety of camera applications.

### SUMMARY

Systems and methods disclosed herein provide for thermal image systems and methods, in accordance with one or more embodiments. For example, for one or more embodiments, systems and methods are disclosed that may provide for wireless thermal imaging, which may include a communication component adapted to remotely communicate with a user over a network, one or more wireless thermal image sensors adapted to capture and provide thermal images of structural objects of a structure for monitoring moisture and/or temperature of the structural objects, and a processing component adapted to receive the thermal images of the structural objects from the one or more wireless thermal image sensors, and process the thermal images of the structural objects to generate moisture and/or temperature content information for remote analysis (e.g., of restoration conditions or fire hazard conditions) of the structural objects.

In various embodiments, the one or more wireless thermal image sensors may include one or more infrared cameras adapted to continuously monitor environmental parameters including one or more of humidity, temperature, and/or moisture associated with the structural objects. The wireless thermal imaging system may include a ruggedized thermal camera system adapted for use as a disaster monitoring camera system to detect and monitor damage from disastrous events including at least one of flooding, fire, explosion, and/or earthquake, and wherein the ruggedized thermal camera system comprises an enclosure that is capable of withstanding disastrous events. The wireless thermal imaging system may include a thermal camera system adapted for use as a safety monitoring system to detect one or more persons in the structure including, for example, one or more fallen persons in the structure.

In various embodiments, the one or more wireless thermal image sensors may be adapted to monitor one more conditions of the structure including measuring one or more of moisture, humidity, temperature, and/or ambient conditions of its structural envelope. Condition information of the structural objects may be collected locally via the processing component and provided to a hosted website over the network via the communication component for remote viewing and analysis (e.g., of restoration conditions) by the user. The wireless thermal imaging system may include wireless sensors including a moisture meter and/or a hygrometer to monitor moisture conditions and provide ambient and/or various types of moisture information related to the structure to the processing component. The infrared imaging system may be adapted to simultaneously monitor multiple structures. The one or more wireless thermal image sensors may be affixed to at least one structural object of the structure to provide a view of one or more other structural objects of the structure. The processing component may be adapted to provide an alarm to remotely notify the user of an emergency (e.g., a disastrous event) related to the structure by setting (or based on) a threshold condition for certain parameters (e.g., with specific moisture or temperature ranges).

An infrared camera system, in accordance with one or more embodiments, may be installed within a public or private facility or area to detect and monitor any persons present. For example, the infrared camera system may be installed within an elder care facility (e.g., senior living facility) or within a daycare facility to monitor persons and detect when assistance may be needed and provide an alert (e.g., a local alarm and/or provide a notification to a designated authority). The infrared camera system may detect when assistance is needed based upon a person's body position (e.g., fallen person), a body temperature (e.g., above or below normal range), and/or total time (e.g., in a stationary position). Additionally, the infrared camera system may be designed to provide lower resolution images to maintain the personal privacy of the person.

The scope of the disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a block diagram illustrating an infrared imaging system for capturing and processing infrared images, in accordance with an embodiment.

FIG. 2 shows a method for capturing and processing infrared images, in accordance with an embodiment.

FIG. 3 shows a block diagram illustrating an infrared imaging system for monitoring an area, in accordance with an embodiment.

FIG. 4 shows a block diagram illustrating a processing flow of an infrared imaging system, in accordance with one or more embodiments.

FIGS. 5A-5B shows a diagram illustrating various profiles of a person, in accordance with one or more embodiments.

FIG. 6 shows a block diagram illustrating a method for capturing and processing infrared images, in accordance with one or more embodiments.

FIGS. 7A-7C show block diagrams illustrating methods for operating an infrared imaging system in an emergency mode, in accordance with one or more embodiments.

FIG. 8 shows an infrared imaging system adapted for monitoring a structure, in accordance with an embodiment.

Embodiments of the present disclosure and their advantages are best understood by referring to the detailed description that follows. It should be appreciated that like reference numerals are used to identify like elements illustrated in one or more of the figures.

### DETAILED DESCRIPTION

Infrared imaging systems and methods disclosed herein, in accordance with one or more embodiments, relate to search, rescue, evacuation, remediation, and/or detection of persons that may be injured (e.g., from a fall) and/or structures that may be damaged due to a disastrous event (emergency), such as an earthquake, explosion, flood, fire, tornado, terrorist attack, etc. For example, in the event of an emergency or disaster with potential loss of power, it may be critical for search and rescue personnel to quickly and easily locate persons in a structure, building, or other defined perimeter. Even under non-emergency conditions, it may be important to quickly and easily assist a person that has fallen. As an example for a structure, it may be necessary to monitor remediation efforts (e.g., due to water or fire damage), such as to verify status or completion of the remediation effort (e.g., the dampness has been remedied) and if further attention is needed (e.g., fire has restarted or potential fire hazard increasing due to increased temperature readings).

Infrared imaging systems and methods disclosed herein, in accordance with one or more embodiments, autonomously operate in total or near total darkness, such as night time or during a power outage. In the event of a total or partial collapse of a structure or building, a ruggedized infrared imaging system may be adapted to withstand impact of a structural collapse and provide a homing signal to identify locations for retrieval of infrared data and information. A low resolution infrared imaging system may be utilized in places where personal privacy is a concern, such as bedrooms, restrooms, and showers. In some instances, these areas are places where persons often slip and fall and may need assistance. As such, the infrared imaging systems and methods disclosed herein provide an infrared camera capable of imaging in darkness, operating autonomously, retaining video information from emergency or other disastrous event (e.g. ruggedized infrared camera), providing an easily identifiable location, and/or protecting personal privacy.

As a specific example, the infrared imaging systems and methods disclosed herein, in accordance with an embodiment, may be utilized in senior citizen care facilities, within a person's home, and/or within other public or private facilities to monitor and provide thermal images that may be analyzed to determine if a person needs assistance (e.g., has fallen or is in distress, has an abnormal body temperature, and/or remains in a fixed position for an extended period of time) and/or provide location information for emergency personnel to locate the individual to provide assistance (e.g., during a medical emergency or during a disaster event).

As another specific example, the infrared imaging systems and methods disclosed herein, in accordance with an embodiment, may be implemented to monitor remediation efforts, such as directed to water and/or fire damage. The infrared imaging system may provide thermal images for analysis within the infrared imager (e.g., infrared camera) or by a remote processor (e.g., computer) to provide information as to the remediation status. As a specific example, the thermal images may provide information as to the moisture, humidity, and/or temperature status of a structure and whether the structure has sufficiently dried after water damage, such that appropriate remediation personnel may readily determine the remediation status. As another specific example, the thermal images may provide information as to the temperature status of a structure, which may have suffered recently from fire damage, and whether the structure and temperatures associated with the structure have stabilized or are increasing, such that appropriate fire personnel may readily determine the fire hazard status and whether the danger of the fire restarting (e.g., rekindle) is increasing so that appropriate actions may be taken.

Accordingly for an embodiment, an infrared imaging system in a ruggedized enclosure with capability of operating autonomously aids first responders including search and rescue personnel by identifying images of persons present at the imaged location. The infrared imaging system is adapted to provide a thermal signature of objects in complete darkness and detect objects that are close to skin temperature. By enclosing the infrared imaging system in such a way that it may withstand severe impact and by equipping the infrared imaging system with non-volatile memory for storing images, first responders upon locating the infrared imaging system may extract infrared data and information about persons present in a specific location.

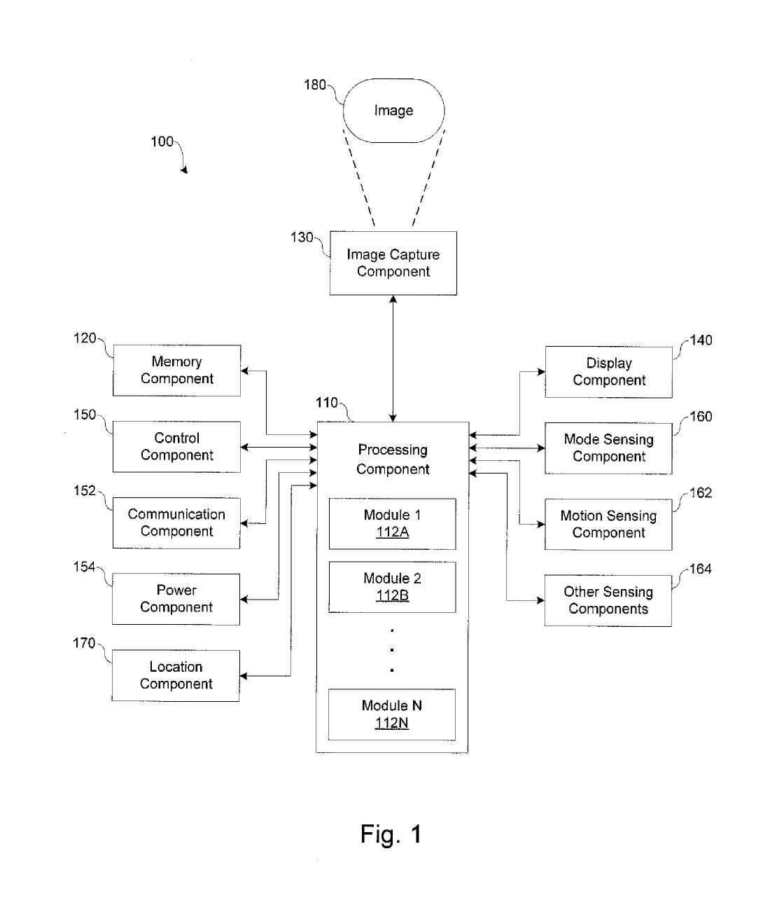

FIG. 1 shows a block diagram illustrating an infrared imaging system 100 for capturing and processing infrared images, in accordance with an embodiment. For example, in one embodiment, infrared imaging system 100 may comprise a rugged thermal imaging camera system to aid first responders and detect fallen persons or persons requiring medical assistance. In another embodiment, infrared imaging system 100 may comprise a wireless thermal image monitoring system for disaster restoration monitoring.

Infrared imaging system 100, in one embodiment, may include a processing component 110, a memory component 120, an image capture component 130, a display component 140, a control component 150, a communication component 152, a power component 154, a mode sensing component 160, a motion sensing component 162, and/or a location component 170. In various embodiments, infrared imaging system 100 may include one or more other sensing components 164 including one or more of a seismic activity sensor, a smoke detection sensor, a heat sensor, a water level sensor, a gaseous fume sensor, a radioactivity sensor, etc.

In various embodiments, infrared imaging system 100 may represent an infrared imaging device, such as an infrared camera, to capture images, such as image 180. Infrared imaging system 100 may represent any type of infrared camera system, which for example may be adapted to detect infrared radiation and provide representative infrared image data (e.g., one or more snapshot images and/or video images). In one embodiment, infrared imaging system 100 may represent an infrared camera and/or video camera that is directed to the near, middle, and/or far infrared spectrums to provide thermal infrared image data. Infrared imaging system 100 may include a permanently mounted infrared imaging device and may be implemented, for example, as a security camera and/or coupled, in other examples, to various types of structures (e.g., buildings bridges, tunnels, etc.). Infrared imaging system 100 may include a portable infrared imaging device and may be implemented, for example, as a handheld device and/or coupled, in other examples, to various types of vehicles (e.g., land-based vehicles, watercraft, aircraft, spacecraft, etc.) or structures via one or more types of mounts. In still another example, infrared imaging system 100 may be integrated as part of a non-mobile installation requiring infrared images to be stored and/or displayed.

Processing component 110 comprises, in various embodiments, an infrared image processing component and/or an infrared video image processing component. Processing component 110 includes, in one embodiment, a microprocessor, a single-core processor, a multi-core processor, a microcontroller, a logic device (e.g., programmable logic device configured to perform processing functions), a digital signal processing (DSP) device, or some other type of generally known processor, including image processors and/or video processors. Processing component 110 is adapted to interface and communicate with components 120, 130, 140, 150, 152, 154, 160, 162, 164, and/or 170 to perform method and processing steps as described herein. Processing component 110 may include one or more modules 112A-112N for operating in one or more modes of operation, wherein modules 112A-112N may be adapted to define preset processing and/or display functions that may be embedded in processing component 110 or stored on memory component 120 for access and execution by processing component 110. For example, processing component 110 may be adapted to operate and/or function as a video recorder controller adapted to store recorded video images in memory component 120. In other various embodiments, processing component 110 may be adapted to perform various types of image processing algorithms and/or various modes of operation, as described herein.

In various embodiments, it should be appreciated that each module 112A-112N may be integrated in software and/or hardware as part of processing component 110, or code (e.g., software or configuration data) for each mode of operation associated with each module 112A-112N, which may be stored in memory component 120. Embodiments of modules 112A-112N (i.e., modes of operation) disclosed herein may be stored by a separate computer-readable medium (e.g., a memory, such as a hard drive, a compact disk, a digital video disk, or a flash memory) to be executed by a computer (e.g., logic or processor-based system) to perform various methods disclosed herein.

In one example, the computer-readable medium may be portable and/or located separate from infrared imaging system 100, with stored modules 112A-112N provided to infrared imaging system 100 by coupling the computer-readable medium to infrared imaging system 100 and/or by infrared imaging system 100 downloading (e.g., via a wired or wireless link) the modules 112A-112N from the computer-readable medium (e.g., containing the non-transitory information). In various embodiments, as described herein, modules 112A-112N provide for improved infrared camera processing techniques for real time applications, wherein a user or operator may change a mode of operation depending on a particular application, such as monitoring seismic activity, monitoring workplace safety, monitoring disaster restoration, etc. Accordingly, in various embodiments, the other sensing components 164 may include one or more of a seismic activity sensor, a smoke detection sensor, a heat sensor, a water level sensor, a humidity sensor, a gaseous fume sensor, a radioactivity sensor, etc. for sensing disastrous events, such as earthquakes, explosions, fires, gas fumes, gas leaks, nuclear meltdowns, etc.

In various embodiments, modules 112A-112N may be utilized by infrared imaging system 100 to perform one or more different modes of operation including a standard mode of operation, a person detection mode of operation, a fallen person mode of operation, an emergency mode of operation, and a black box mode of operation. One or more of these modes of operation may be utilized for work and safety monitoring, disaster monitoring, restoration monitoring, and/or remediation progress monitoring. The modes of operation are described in greater detail herein.

Memory component 120 includes, in one embodiment, one or more memory devices to store data and information, including infrared image data and information and infrared video image data and information. The one or more memory devices may include various types of memory for infrared image and video image storage including volatile and non-volatile memory devices, such as RAM (Random Access Memory), ROM (Read-Only Memory), EEPROM (Electrically-Erasable Read-Only Memory), flash memory, etc. In one embodiment, processing component 110 is adapted to execute software stored on memory component 120 to perform various methods, processes, and modes of operations in manner as described herein.

Image capture component 130 includes, in one embodiment, one or more infrared sensors (e.g., any type of infrared detector, such as a focal plane array) for capturing infrared image signals representative of an image, such as image 180. The infrared sensors may be adapted to capture infrared video image signals representative of an image, such as image 180. In one embodiment, the infrared sensors of image capture component 130 provide for representing (e.g., converting) a captured image signal of image 180 as digital data (e.g., via an analog-to-digital converter included as part of the infrared sensor or separate from the infrared sensor as part of infrared imaging system 100). Processing component 110 may be adapted to receive infrared image signals from image capture component 130, process infrared image signals (e.g., to provide processed image data), store infrared image signals or image data in memory component 120, and/or retrieve stored infrared image signals from memory component 120. Processing component 110 may be adapted to process infrared image signals stored in memory component 120 to provide image data (e.g., captured and/or processed infrared image data) to display component 140 for viewing by a user.

Display component 140 includes, in one embodiment, an image display device (e.g., a liquid crystal display (LCD)) or various other types of generally known video displays or monitors. Processing component 110 may be adapted to display image data and information on display component 140. Processing component 110 may be adapted to retrieve image data and information from memory component 120 and display any retrieved image data and information on display component 140. Display component 140 may include display electronics, which may be utilized by processing component 110 to display image data and information (e.g., infrared images). Display component 140 may receive image data and information directly from image capture component 130 via processing component 110, or the image data and information may be transferred from memory component 120 via processing component 110.

In one embodiment, processing component 110 may initially process a captured image and present a processed image in one mode, corresponding to modules 112A-112N, and then upon user input to control component 150, processing component 110 may switch the current mode to a different mode for viewing the processed image on display component 140 in the different mode. This switching may be referred to as applying the infrared camera processing techniques of modules 112A-112N for real time applications, wherein a user or operator may change the mode while viewing an image on display component 140 based on user input to control component 150. In various aspects, display component 140 may be remotely positioned, and processing component 110 may be adapted to remotely display image data and information on display component 140 via wired or wireless communication with display component 140.

Control component 150 includes, in one embodiment, a user input and/or interface device having one or more user actuated components. For example, actuated components may include one or more push buttons, slide bars, rotatable knobs, and/or a keyboard, that are adapted to generate one or more user actuated input control signals. Control component 150 may be adapted to be integrated as part of display component 140 to function as both a user input device and a display device, such as, for example, a touch screen device adapted to receive input signals from a user touching different parts of the display screen. Processing component 110 may be adapted to sense control input signals from control component 150 and respond to any sensed control input signals received therefrom.

Control component 150 may include, in one embodiment, a control panel unit (e.g., a wired or wireless handheld control unit) having one or more user-activated mechanisms (e.g., buttons, knobs, sliders, etc.) adapted to interface with a user and receive user input control signals. In various embodiments, the one or more user-activated mechanisms of the control panel unit may be utilized to select between the various modes of operation, as described herein in reference to modules 112A-112N. In other embodiments, it should be appreciated that the control panel unit may be adapted to include one or more other user-activated mechanisms to provide various other control functions of infrared imaging system 100, such as auto-focus, menu enable and selection, field of view (FoV), brightness, contrast, gain, offset, spatial, temporal, and/or various other features and/or parameters. In still other embodiments, a variable gain signal may be adjusted by the user or operator based on a selected mode of operation.

In another embodiment, control component 150 may include a graphical user interface (GUI), which may be integrated as part of display component 140 (e.g., a user actuated touch screen), having one or more images of the user-activated mechanisms (e.g., buttons, knobs, sliders, etc.), which are adapted to interface with a user and receive user input control signals via the display component 140.

Communication component 152 may include, in one embodiment, a network interface component (NIC) adapted for wired and/or wireless communication with a network including other devices in the network. In various embodiments, communication component 152 may include a wireless communication component, such as a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components, such as wireless transceivers, adapted for communication with a wired and/or wireless network. As such, communication component 152 may include an antenna coupled thereto for wireless communication purposes. In other embodiments, the communication component 152 may be adapted to interface with a wired network via a wired communication component, such as a DSL (e.g., Digital Subscriber Line) modem, a PSTN (Public Switched Telephone Network) modem, an Ethernet device, and/or various other types of wired and/or wireless network communication devices adapted for communication with a wired and/or wireless network. Communication component 152 may be adapted to transmit and/or receive one or more wired and/or wireless video feeds.

In various embodiments, the network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) adapted to communicate with other communication networks, such as the Internet. As such, in various embodiments, the infrared imaging system 100 may be associated with a particular network link such as for example a URL (Uniform Resource Locator), an IP (Internet Protocol) address, and/or a mobile phone number.

Power component 154 comprises a power supply or power source adapted to provide power to infrared imaging system 100 including each of the components 110, 120, 130, 140, 150, 152, 154, 160, 162, 164, and/or 170. Power component 154 may comprise various types of power storage devices, such as battery, or a power interface component that is adapted to receive external power and convert the received external power to a useable power for infrared imaging system 100 including each of the components 110, 120, 130, 140, 150, 152, 154, 160, 162, 164, and/or 170.

Mode sensing component 160 may be optional. Mode sensing component 160 may include, in one embodiment, an application sensor adapted to automatically sense a mode of operation, depending on the sensed application (e.g., intended use for an embodiment), and provide related information to processing component 110. In various embodiments, the application sensor may include a mechanical triggering mechanism (e.g., a clamp, clip, hook, switch, push-button, etc.), an electronic triggering mechanism (e.g., an electronic switch, push-button, electrical signal, electrical connection, etc.), an electro-mechanical triggering mechanism, an electro-magnetic triggering mechanism, or some combination thereof. For example, for one or more embodiments, mode sensing component 160 senses a mode of operation corresponding to the intended application of the infrared imaging system 100 based on the type of mount (e.g., accessory or fixture) to which a user has coupled the infrared imaging system 100 (e.g., image capture component 130). Alternately, for one or more embodiments, the mode of operation may be provided via control component 150 by a user of infrared imaging system 100.

Mode sensing component 160, in one embodiment, may include a mechanical locking mechanism adapted to secure the infrared imaging system 100 to a structure or part thereof and may include a sensor adapted to provide a sensing signal to processing component 110 when the infrared imaging system 100 is mounted and/or secured to the structure. Mode sensing component 160, in one embodiment, may be adapted to receive an electrical signal and/or sense an electrical connection type and/or mount type and provide a sensing signal to processing component 110.

Processing component 110 may be adapted to communicate with mode sensing component 160 (e.g., by receiving sensor information from mode sensing component 160) and image capture component 130 (e.g., by receiving data and information from image capture component 130 and providing and/or receiving command, control, and/or other information to and/or from other components of infrared imaging system 100).

In various embodiments, mode sensing component 160 may be adapted to provide data and information relating to various system applications including various coupling implementations associated with various types of structures (e.g., buildings, bridges, tunnels, vehicles, etc.). In various embodiments, mode sensing component 160 may include communication devices that relay data and information to processing component 110 via wired and/or wireless communication. For example, mode sensing component 160 may be adapted to receive and/or provide information through a satellite, through a local broadcast transmission (e.g., radio frequency), through a mobile or cellular network, and/or through information beacons in an infrastructure (e.g., a transportation or highway information beacon infrastructure) or various other wired and/or wireless techniques.

Motion sensing component 162 includes, in one embodiment, a motion detection sensor adapted to automatically sense motion or movement and provide related information to processing component 110. For example, motion sensing component 162 may include an accelerometer, a gyroscope, an inertial measurement unit (MU), etc., to detect motion of infrared imaging system 100 (e.g., to detect an earthquake). In various embodiments, the motion detection sensor may be adapted to detect motion or movement by measuring change in speed or vector of an object or objects in a field of view, which may be achieved by mechanical techniques physically interacting within the field of view or by electronic techniques adapted to quantify and measure changes in the environment. Some methods by which motion or movement may be electronically identified include optical detection and acoustical detection.

In various embodiments, image capturing system 100 may include one or more other sensing components 164, including environmental and/or operational sensors, depending on application or implementation, which provide information to processing component 110 by receiving sensor information from each sensing component 164. In various embodiments, other sensing components 164 may be adapted to provide data and information related to environmental conditions, such as internal and/or external temperature conditions, lighting conditions (e.g., day, night, dusk, and/or dawn), humidity levels, specific weather conditions (e.g., sun, rain, and/or snow), distance (e.g., laser rangefinder), and/or whether a tunnel, a covered parking garage, or some type of structure or enclosure is detected. As such, other sensing components 160 may include one or more conventional sensors as known by those skilled in the art for monitoring various conditions (e.g., environmental conditions) that may have an affect (e.g., on the image appearance) on the data and information provided by image capture component 130.

In some embodiments, other sensing components 164 may include devices that relay information to processing component 110 via wireless communication. For example, each sensing component 164 may be adapted to receive information from a satellite, through a local broadcast (e.g., radio frequency) transmission, through a mobile or cellular network and/or through information beacons in an infrastructure (e.g., a transportation or highway information beacon infrastructure), and/or various other wired and/or wireless techniques in accordance with one or more embodiments.

Location component 170 includes, in one embodiment, a beacon signaling device adapted to provide a homing beacon signal for location discovery of the infrared imaging system 100. In various embodiments, the homing beacon signal may utilize a radio frequency (RF) signal, microwave frequency (MWF) signal, and/or various other wireless frequency signals in accordance with embodiments. As such, location component 170 may utilize an antenna coupled thereto for wireless communication purposes. In one aspect, processing component 110 may be adapted to interface with location component 170 to transmit the homing beacon signal in the event of an emergency or disastrous event.

In various embodiments, one or more components 110, 120, 130, 140, 150, 152, 154, 160, 162, 164, and/or 170 of image capturing system 100 may be combined and/or implemented or not, as desired or depending on application requirements, with image capturing system 100 representing various functional blocks of a system. For example, processing component 110 may be combined with memory component 120, image capture component 130, display component 140, and/or mode sensing component 160. In another example, processing component 110 may be combined with image capture component 130 with only certain functions of processing component 110 performed by circuitry (e.g., processor, logic device, microprocessor, microcontroller, etc.) within image capture component 130. In still another example, control component 150 may be combined with one or more other components or be remotely connected to at least one other component, such as processing component 110, via a wired or wireless control device so as to provide control signals thereto.

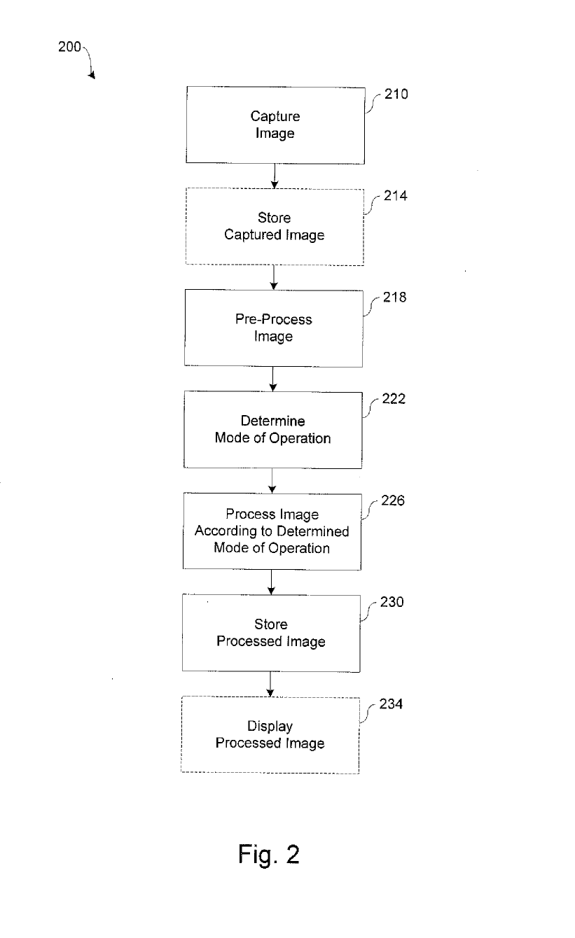

FIG. 2 shows a method 200 illustrating a process flow for capturing and processing infrared images, in accordance with an embodiment. For purposes of simplifying discussion of FIG. 2, reference may be made to image capturing system 100 of FIG. 1 as an example of a system, device, or apparatus that may perform method 200.

Referring to FIG. 2, one or more images (e.g., infrared image signals comprising infrared image data including video data) may be captured (block 210) with infrared imaging system 100. In one embodiment, processing component 110 controls (e.g., causes) image capture component 130 to capture one or more images, such as, for example, image 180 and/or a video image of image 180. In one aspect, after receiving one or more captured images from image capture component 130, processing component 110 may be adapted to optionally store captured images (block 214) in memory component 120 for processing.

The one or more captured images may be pre-processed (block 218). In one embodiment, pre-processing may include obtaining infrared sensor data related to the captured images, applying correction terms, and applying noise reduction techniques to improve image quality prior to further processing as would be understood by one skilled in the art. In another embodiment, processing component 110 may directly pre-process the captured images or optionally retrieve captured images stored in memory component 120 and then pre-process the images. In one aspect, pre-processed images may be optionally stored in memory component 120 for further processing.

For one or more embodiments, a mode of operation may be determined (block 222), and one or more captured and/or preprocessed images may be processed according to the determined mode of operation (block 226). In one embodiment, the mode of operation may be determined before or after the images are captured and/or preprocessed (blocks 210 and 218), depending upon the types of infrared detector settings (e.g., biasing, frame rate, signal levels, etc.), processing algorithms and techniques, and related configurations.

In one embodiment, a mode of operation may be defined by mode sensing component 160, wherein an application sensing portion of mode sensing component 160 may be adapted to automatically sense the mode of operation, and depending on the sensed application, mode sensing component 160 may be adapted to provide related data and/or information to processing component 110.

In another embodiment, it should be appreciated that the mode of operation may be manually set by a user via display component 140 and/or control component 150 without departing from the scope of the present disclosure. As such, in one aspect, processing component 110 may communicate with display component 140 and/or control component 150 to obtain the mode of operation as provided (e.g., input) by a user. The modes of operation may include the use of one or more infrared image processing algorithms and/or image processing techniques.

In various embodiments, the modes of operation refer to processing and/or display functions of infrared images, wherein for example an infrared imaging system is adapted to process infrared sensor data prior to displaying the data to a user. In some embodiments, infrared image processing algorithms are utilized to present an image under a variety of conditions, and the infrared image processing algorithms provide the user with one or more options to tune parameters and operate the infrared imaging system in an automatic mode or a manual mode. In various embodiments, the modes of operation are provided by infrared imaging system 100, and the concept of image processing for different use conditions may be implemented in various types of structure applications and resulting use conditions.

In various embodiments, the modes of operation may include a standard mode of operation, a person detection mode of operation, a fallen or distressed person mode of operation, an emergency mode of operation, and/or a black box mode of operation. One or more of these modes of operation may be utilized for work and safety monitoring, disaster monitoring, restoration monitoring, and/or remediation progress monitoring. In various embodiments, one or more of sensing components 160, 162, 164 may be utilized to determine a mode of operation. For example, mode sensing component 160 may be adapted to interface with motion sensing component 162 and one or more other sensing components 164 to assist with a determination of a mode of operation. The other sensing components 164 may include one or more of a seismic activity sensor, a smoke detection sensor, a heat sensor, a water level sensor, a moisture sensor, a temperature sensor, a humidity sensor, a gaseous fume sensor, a radioactivity sensor, etc. for sensing disastrous events, such as earthquakes, explosions, fires, gas fumes, gas leaks, nuclear events, etc. The modes of operation are described in further detail herein.

After processing the one or more images according to a determined mode of operation (block 226), the one or more images may be stored (block 230, i.e., after processing or prior to processing) and optionally displayed (block 234). Additionally, further processing may be optionally performed depending on application or implementation.

For example, for an embodiment, images may be displayed in a night mode, wherein the processing component 110 may be adapted to configure display component 140 to apply a night color palette to the images for display in night mode. In night mode, an image may be displayed in a red palette or a green palette to improve night vision capacity (e.g., to minimize night vision degradation) for a user. Otherwise, if night mode is not considered necessary, then processing component 110 may be adapted to configure display component 140 to apply a non-night mode palette (e.g., black hot or white hot palette) to the images for display via display component 140.

In various embodiments, processing component 110 may store any of the images, processed or otherwise, in memory component 120. Accordingly, processing component 110 may, at any time, retrieve stored images from memory component 120 and display retrieved images on display component 140 for viewing by a user.

In various embodiments, the night mode of displaying images refers to using a red color palette or green color palette to assist the user or operator in the dark when adjusting to low light conditions. During night operation of image capturing system 100, human visual capacity to see in the dark may be impaired by the blinding effect of a bright image on a display monitor. Hence, the night mode changes the color palette from a standard black hot or white hot palette to a red or green color palette display. Generally, the red or green color palette is known to interfere less with human night vision capability. In one example, for a red-green-blue (RGB) type of display, the green and blue pixels may be disabled to boost red color for a red color palette. In one aspect, the night mode display may be combined with any other mode of operation of infrared imaging system 100, and a default display mode of infrared imaging system 100 at night may be the night mode display.

In various embodiments, processing component 110 may switch the processing mode of a captured image in real time and change the displayed processed image from one mode, corresponding to modules 112A-112N, to a different mode upon receiving input from mode sensing component 160 and/or user input from control component 150. As such, processing component 110 may switch a current mode of display to another different mode of display for viewing the processed image by the user or operator on display component 140 depending on the input received from mode sensing component 160 and/or user input from control component 150. This switching may be referred to as applying the infrared camera processing techniques of modules 112A-112N for real time applications, wherein the displayed mode may be switched while viewing an image on display component 140 based on the input received from mode sensing component 160 and/or user input received from control component 150.

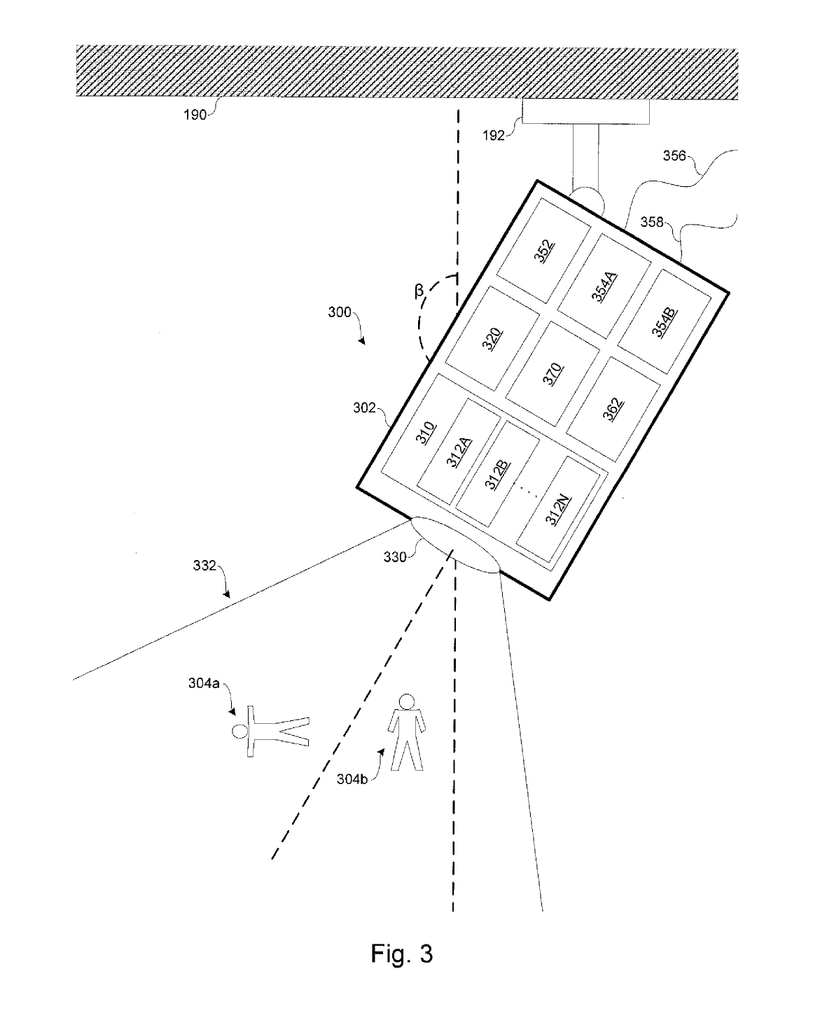

FIG. 3 shows a block diagram illustrating an infrared imaging system 300 for monitoring an area, in accordance with an embodiment. For example, in one embodiment, infrared imaging system 300 may comprise a rugged thermal imaging camera system for utilization as a disaster camera and/or workplace safety monitoring to aid first responders and/or detect fallen persons. In another embodiment, infrared imaging system 300 may comprise a wireless thermal imaging system and/or a wireless thermal image monitoring system for disaster and/or restoration monitoring. For purposes of simplifying discussion of FIG. 3, reference may be made to image capturing system 100 of FIG. 1, wherein similar system components have similar scope and function.

In one embodiment, infrared imaging system 300 may comprise an enclosure 302 (e.g., a highly ruggedized protective housing), a processing component 310 (e.g., a video processing device having a module for detecting a fallen person, emergency, disastrous event, etc.), a memory component 320 (e.g., video storage, recording unit, flash drive, etc.), an image capture component 330 (e.g., a radiometrically calibrated thermal camera), a communication component 352 (e.g., a transceiver having wired and/or wireless communication capability), a first power component 354A (e.g., a battery), a second power component 354B (e.g., a power interface receiving external power via a power cable 356), a motion sensing component 362 (e.g., a sensor sensitive to motion or movement, such as an accelerometer), and a location component 370 (e.g., a homing beacon signal generator). Infrared imaging system 300 may further include other types of sensors, as discussed herein, such as a temperature sensor, a humidity sensor, and/or a moisture sensor.

During normal operation, the system 300 may be adapted to provide a live video feed of thermal video captured with image capture component 330 through a wired cable link 358 or wireless communication link 352. Captured video images may be utilized for surveillance operations. The system 300 may be adapted to automatically detect a fallen person or a person in need of assistance (e.g., based on body temperature, location, body position, and/or motionless for a period of time). The fallen person detection system utilizes the image capture component 330 as a radiometrically calibrated thermal imager. The system 300 may be securely mounted to a structure 190 via an adjustable mounting component 192 (e.g., fixed or moveable, such as a pan/tilt or other motion control device) so that the imaging component 330 may be tilted to peer down on persons 304a, 304b within a field of view (FOV) 332. In one embodiment, radiometric calibration allows the system 300 to detect objects (e.g., persons 304a, 304b) at or close to skin temperature, such as between 80° C. and 110° F.

In one embodiment, the processing component 310 utilizes a person detection module 312B (i.e., module 112B) to determine or provide awareness of whether one or more persons are present in the scene, such as persons 304a, 304b. If at least one person is present, then the system 300 may be adapted to operate in emergency mode 312A (e.g., module 112A), which may be triggered by motion sensor 362. The processing component 310 may encode person detection information into a homing beacon signal, which may be generated from location device 370. In one aspect, the person detection information may aid search and rescue personnel in their efforts to prioritize search and rescue operations.

In one embodiment, the system 300 may be enclosed in a ruggedized protective housing 302 built such that even after severe impact from a disastrous event, the non-volatile memory 320, which stores recorded video images, may be extracted in an intact state. An internal battery 354 allows the system 300 to operate after loss of external power via cable 356 for some period of time. Even if the system optics and video processing electronics are rendered useless as a result of a catastrophic event, power from internal battery 354 may be provided to location device 370 so that a homing beacon signal may be generated and transmitted to assist search and rescue personnel with locating the system 300.

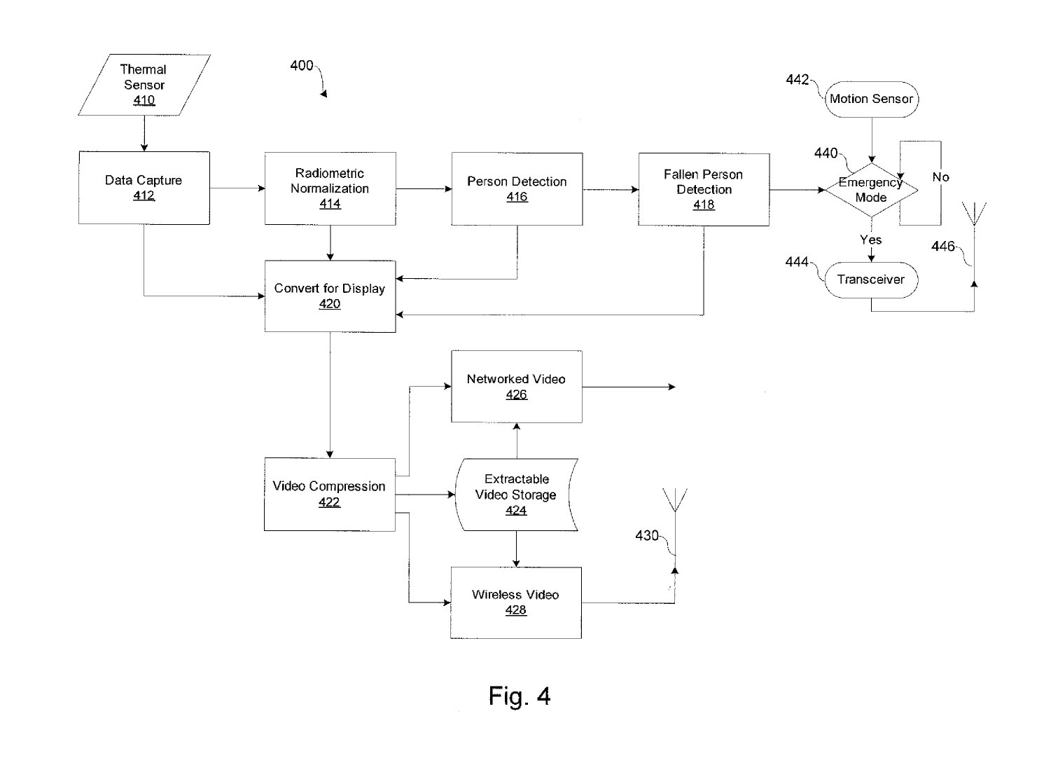

FIG. 4 shows a block diagram illustrating a process flow 400 of an infrared imaging system, in accordance with one or more embodiments. For example, system 100 of FIG. 1 and/or system 300 in FIG. 3 may be utilized to perform method 400.

In one embodiment, a data capture component 412 (e.g., processing component 310 of system 300) is adapted to extract frames of thermal imagery from a thermal infrared sensor 410 (e.g., image capture component 330 of system 300). The captured image, including data and information thereof, may be normalized, for example, to an absolute temperature scale by a radiometric normalization module 414 (e.g., a module utilized by the processing component 310 of system 300). A person detection module 416 (e.g., a module utilized by the processing component 310 of system 300) is adapted to operate on the radiometric image to localize persons present in the scene (e.g., FOV 332).

A fallen person detection module 418 (e.g., a module utilized by the processing component 310 of system 300) may be adapted to discriminate between upright persons (e.g., standing or walking persons) and fallen persons. In various embodiments, the module may be adapted to discriminate based on other parameters, such as time, location, and/or temperature differential.

For example, process flow 400 may be used to monitor persons and detect when assistance may be needed and provide an alert (e.g., a local alarm and/or provide a notification to a designated authority). As a specific example, process flow 400 (e.g., person detection module 416) may detect when assistance is needed based upon a person's body position (e.g., fallen person), body temperature (e.g., above or below normal range), and/or total time (e.g., in a stationary position).

In one aspect, data and information about coordinates of persons (e.g., fallen and not fallen) and the radiometrically normalized or non-normalized image may be passed to a conversion module 420 (e.g., a module utilized by the processing component 310 of system 300). The conversion module 420 may be adapted to scale the image such that the image fits the dynamic range of a display and may encode the positions of persons and fallen persons in the image, for example, by color coding the locations. The converted and potentially color coded image may be compressed 422 by some standard video compression algorithm or technique so as to reduce memory storage capacity of the extractable video storage component 424 (e.g., the memory component 320 of system 300). In various aspects, a command may be given to the system 300 by a user or the processing component 310 to transmit stored video data and information of the extractable video storage component 424 over a wired video link 426 and/or wireless video link 428 via an antenna 430.

In one embodiment, in standard operation, the system (e.g., system 300 of FIG. 3) operates as a thermal imaging device producing a video stream representing the thermal signature of a scene (e.g., FOV 332). The video images produced may be stored in a circular frame buffer in non-volatile memory (e.g., memory component 320 of system 300) in a compressed format so as to store a significant amount of video. It should be appreciated that, depending on the memory storage capacity, any length of video may be stored without departing from the scope of the present embodiments. It should also be appreciated that the type of extractable memory module used and the compression ratio may affect the amount of available memory storage as understood by someone skilled in the art.

In one embodiment, in a person detection mode, a processing unit (e.g., processing component 310 of system 300) processing the thermal video stream may be adapted to detect the presence of persons and/or animals. In one embodiment, if a person is detected, the system (e.g., system 300 of FIG. 3) may be set to a PERSON_PRESENT mode, wherein person detection information may be utilized during normal operation as is achieved, for example, in standard video analytics software to generate an alert of potential intrusion. In the event of an emergency, the camera may retain the PERSON_PRESENT mode even when disconnected from main power and video network.

In one aspect, by collecting scene statistics for each pixel location, a background model of the scene (e.g., FOV 332) may be constructed. This may be considered standard procedure in video analytics applications. The exemplary background model may utilize an average of a time series of values for a given pixel. Because of the lack of shadows and general insensitivity to changing lighting conditions, background modeling may be more effective and less prone to false alarms with thermal imaging sensors. Once a background model has been constructed, regions of the image that differ from the background model may be identified. In the instance of a time series average as a background model, the background may be subtracted from the current captured video frame, and the difference may be thresholded to find one or more ROI (Region Of Interest) corresponding to areas of greatest change. In one example, a detected ROI may indicate the presence of a person.

In one embodiment, a radiometrically calibrated thermal camera (e.g., system 300 of FIG. 3) may be utilized, which may allow the fallen person detection module 418 to access absolute temperature values for the ROI. In one example, if the ROT includes at least some areas with temperatures close to body temperature, and if the ROI is of size that may match the profile of a person imaged from the specific camera location, a person may be determined to be present in the captured image. As such, in this instance, the system 300 may be set to PERSON_PRESENT mode. In another example, a user set time constant may determine the length of time that the system 300 may stay in the PERSON_PRESENT mode after the last detection of a person. For instance, the system 300 may stay in the PERSON_PRESENT mode for 10 seconds after the last detection of a person.

In one embodiment, in a fallen person mode for example, a processing unit (e.g., processing component 310 of system 300) processing the thermal video stream may be adapted to discriminate between an upright person (e.g., standing or walking person) and a fallen person. In one embodiment, if a fallen person is detected, the system (e.g., system 300 of FIG. 3) may be adapted to generate an alarm. The alarm may be encoded into the video or transmitted via a wired and/or wireless communication link. In should be appreciated that the process of determining if a person has fallen is described for a fixed mount camera but an approach may be adapted for moving cameras using image registration methods as known by someone skilled in the art.

For example, a thermal imaging system (e.g., system 300 of FIG. 3) may be mounted at an elevated location, such as the ceiling, and may pointed or tilted in such a manner that the system observes the scene (e.g., FOV 332) from a close to 180° angle (e.g., as shown in FIG. 3, β being close to 180°). When mounted in this manner, the profile of a standing person (e.g., person 304b) in the scene (e.g., FOV 332) and the profile of a fallen person (e.g., person 304a) in the scene (e.g., FOV 332) appear different to the infrared imaging system 300. For instance, the standing person 304b, as imaged from above, has, in relative terms, a smaller profile than the fallen person 304a having a larger profile. The approximate size (e.g., profile size based on the number of measured pixels) of a standing or fallen person, relative to the total size of the image (e.g., also determined based on the number of measured pixels), may be determined based on an approximate distance to the ground (or floor) relative to the thermal imaging system. This approximate distance may be provided to the system by an operator (e.g., via a wired or wireless communication link), may be determined based on the focus position, may be measured using a distance measuring sensor (e.g., a laser range finder), or may be determined by analyzing statistical properties of objects moving relative to the background (e.g., analysis performed by the thermal image camera or by a remote processor coupled to or formed as part of the thermal imaging system).

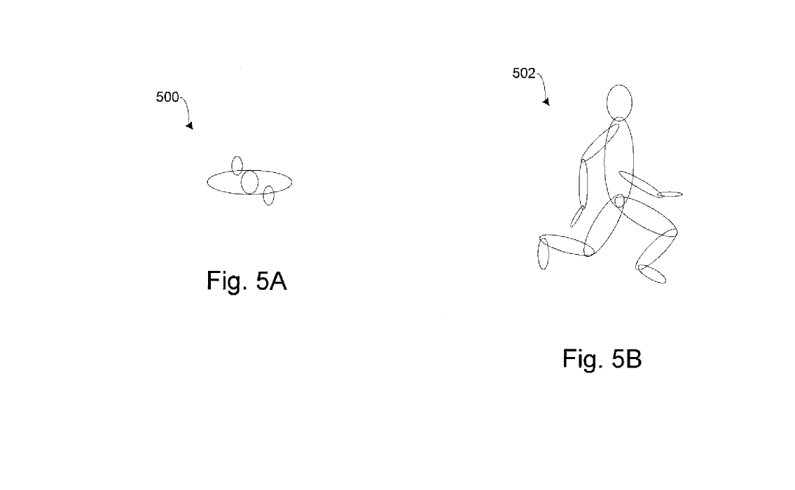

For example, FIG. 5A shows a first profile 500 of an upright person (e.g., standing or walking person, such as person 304b). In another example, FIG. 5B shows a second profile 502 of a fallen person (e.g., such as person 304a). In one aspect, as shown in FIGS. 5A and 5B, the first profile of the upright person is at least smaller than the second profile of the fallen person, which is at least larger than the first profile. In various aspects, the difference between the upright person and the fallen person represents a change in aspect of a person, such as the vertical and/or horizontal aspect of the person. In one embodiment, detection of a fallen person may utilize low resolution radiometry and/or thermal imagery, wherein persons may be imaged as warm blobs that are monitored for their presence, movement, and safety. For example, if someone is detected as fallen, a caregiver may be modified to provide assistance to the fallen person. In another example, the infrared imaging system 300 may be equipped with autonomous two-way audio so that a caregiver may remotely, bi-directionally communicate with a fallen person, if deemed necessary.

In one embodiment, referring to FIG. 4, the person detection mode 416 and/or the fallen person mode 418 provide awareness to the infrared imaging system 300 as to whether one or more persons are present in the scene (e.g., FOV 332). For example, if at least one person is present in the scene, then the system 300 may be adapted to operate in emergency mode 440, which may be triggered by a motion or movement sensor 442 (e.g., motion sensing component 362). The processing component 310 may be adapted to encode person detection information into a communication signal and transmit the communication signal over a network via, for example, a radio frequency (RF) transceiver 444 (e.g., wireless communication component 352) having an antenna 446 (or via antenna 430). In one embodiment, the person detection information may aid search and rescue personnel in their efforts to prioritize search and rescue operations.

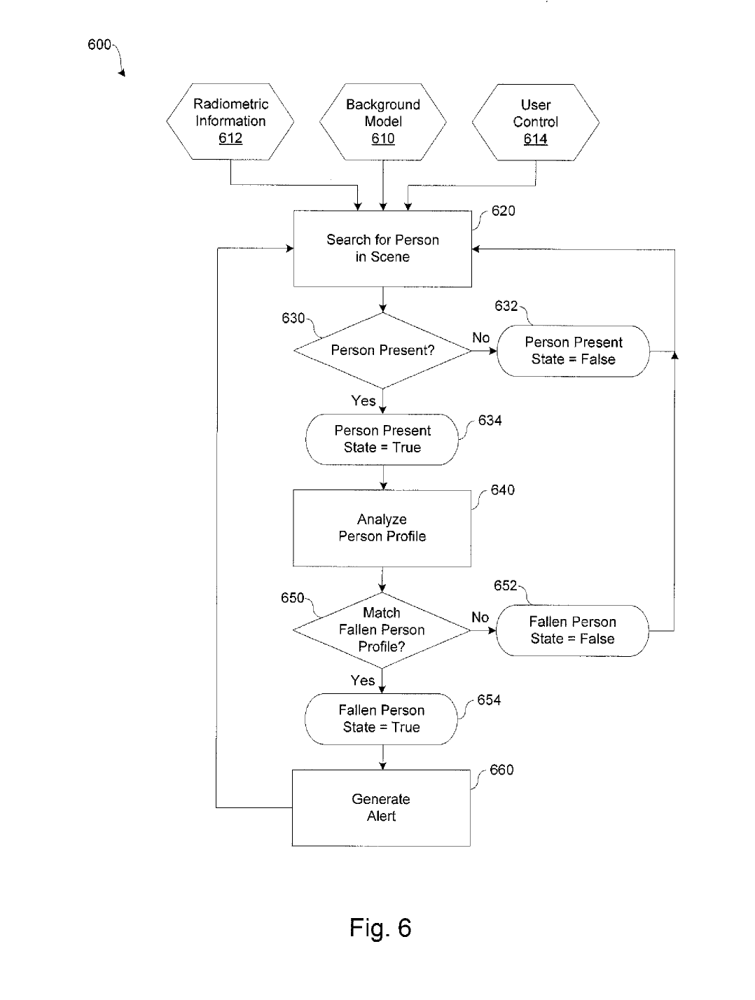

FIG. 6 shows a block diagram illustrating a method 600 for detecting a person in a scene or field of view, in accordance with one or more embodiments. For example, system 100 of FIG. 1 and/or system 300 of FIG. 3 may be utilized to perform method 600.

In one embodiment, using the method described in FIG. 4 for detecting a person in a scene (e.g., FOV 332) in the person detection mode, a fallen person may be discriminated from a standing or walking person by calculating the size of the ROI (i.e., the size of the area that differs from the background model) and by radiometric properties. By analyzing the change in the scene (e.g., FOV 332) over time, a group of persons walking together (i.e., two or more persons meeting) may be distinguished from a person that suddenly changes position from standing or walking to lying on the ground (i.e., a fallen person). For instance, the speed of which a specific ROI moves across the scene (e.g., FOV 332) may be used as a discriminating parameter since a fallen person may not move or move slowly.

In one aspect, by collecting scene statistics for each pixel location, a background model 610 of the scene (e.g., FOV 332) may be constructed. The background model 610 may utilize an average of a time series of values for a given pixel, and regions of the image that differ from the background model 610 may be identified. In the instance of a time series average as the background model 610, the background may be subtracted from the current captured video frame, and the difference may be thresholded to find one or more ROI (Region Of Interest) corresponding to areas of greatest change, wherein a detected ROI may indicate the presence of a person. Detection of a fallen person may utilize low resolution radiometric information 612 and thermal imagery, wherein persons may be imaged as warm blobs that are monitored for their presence and movement. Detection of a fallen person may involve user control 614 of parameters, such as setting radiometry resolution, identifying ROI, time period for monitoring the scene, etc.

Once the background model 610, radiometric information 612, and user control 614 of parameters are obtained, the method 600 is adapted to search for a person in the scene 620, in a manner as described herein. If a person is not present or not detected, then a person present state is set to false 632, and the method 600 is adapted to continue to search for a person in the scene 620. If a person is present or detected in the scene 630, then the person present state is set to true 634, and the method 600 is adapted to analyze the profile of the detected person in the scene 640, in a manner as described herein. The analysis of the scene 640 may monitor persons and detect when assistance may be needed and provide an alert 660 (e.g., a local alarm and/or provide a notification to a designated authority). As a specific example, method 600 (e.g., person present 630 and/or analysis 640) may detect when assistance is needed based upon a person's body position (e.g., fallen person), body temperature (e.g., above or below normal range), and/or total time (e.g., total time in a stationary, motionless position).

Once the person profile is analyzed 640, the method 600 is adapted to determine if the analyzed profile matches the profile of a fallen person 650. If the profile is not determined to match the profile of a fallen person, then a fallen person state is set to false, and the method 600 is adapted to continue to search for a person in the scene 620. Otherwise, if the profile is determined to match the profile of a fallen person, then the fallen person state is set to true 654, and the method 600 is adapted to generate an alert 660 to notify a user or operator that a fallen person has been detected in the scene. Once the alert is generated 660, the method 600 is adapted to continue to search for a person in the scene 620.

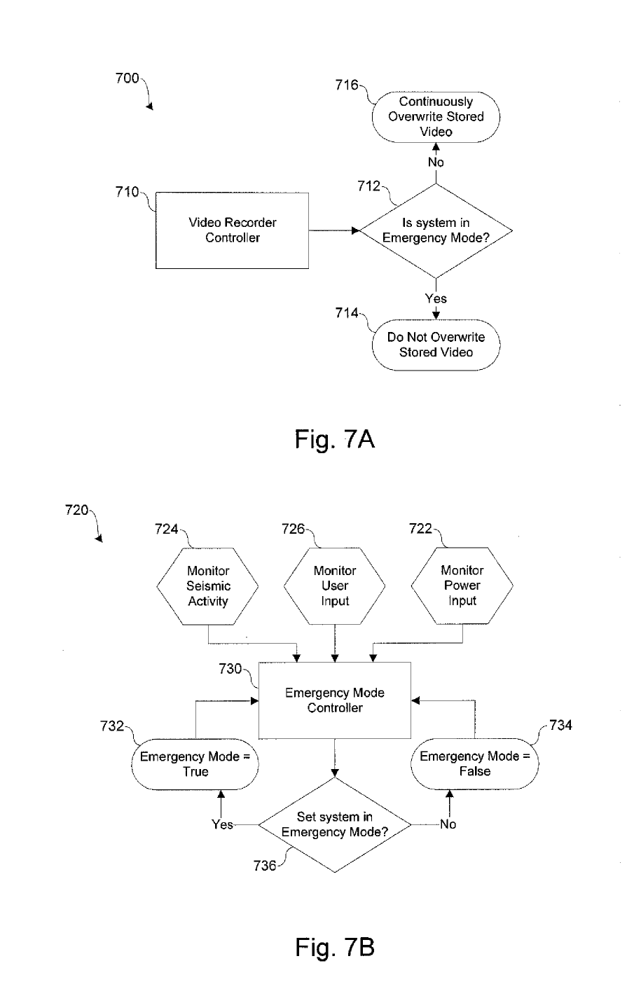

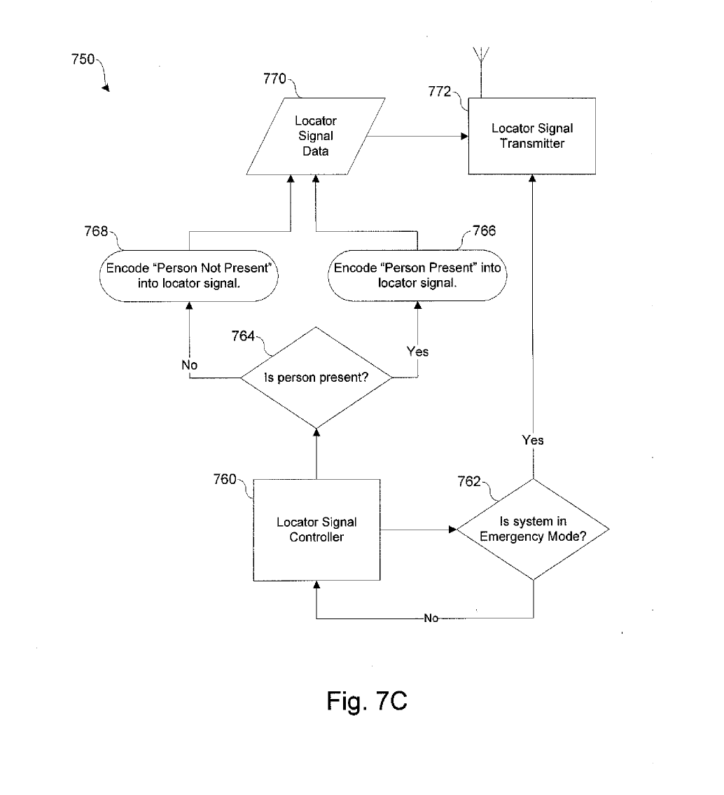

FIGS. 7A-7C show block diagrams illustrating methods 700, 720, and 750, respectively, for operating an infrared imaging system in an emergency mode, in accordance with one or more embodiments. In some embodiments, infrared imaging system 100 of FIG. 1 and/or infrared imaging system 300 of FIG. 3 may be utilized as an example of a system, device, or apparatus that may perform methods 700, 720, and/or 750.

In the emergency mode of operation, the location component 170, 370 is adapted to transmit a homing beacon signal to facilitate locating the system 100, 300, respectively, in a disastrous event, such as in the event of sensed smoke or fire and/or partial or complete collapse of a building. In one embodiment, if the system 100, 300 was operating in PERSON_PRESENT mode at the time when the system 100, 300 entered emergency mode, then a person present notification is encoded into the transmitted homing beacon signal. If more than one person was present, then the approximate number of persons present may be encoded into the transmitted homing beacon signal.

Referring to FIG. 7A, if the infrared imaging system 100, 300 is operational during an emergency, then the system 100, 300 may continue to monitor the scene (e.g., FOV 332) and may change its status to PERSON_PRESENT mode after the system 100, 300 went into emergency mode. In one embodiment, processing component 110, 310 may be adapted to operate and/or function as a video recorder controller 710 adapted to store recorded video images in memory component 120. If the infrared imaging system 100, 300 is determined to be operating in an emergency mode (block 712), then stored video data and information is not erased or overwritten (block 714). Otherwise, if the infrared imaging system 100, 300 is determined to not be operating in an emergency mode (block 712), then stored video data and information is continuously overwritten with new video data and information (block 716).

In one aspect, a user defined setting may be adapted to set a threshold for an amount of stored video data and information prior to the system 100, 300 operating in emergency mode. In another aspect, a maximum time may be defined by an amount of non-volatile memory storage capacity and/or a video data compression ratio. In one example, the system 100, 300 may be configured to have the last ten minutes of video stored and to not overwrite that video history in the event of an emergency. That way, first responders that are able to extract the video from the system (e.g., by extracting the video memory) may be able to determine what happened at a specific location 10 minutes prior to the event that caused the system 100, 300 to enter emergency mode.

In various embodiments, referring to FIG. 7B, different events may cause the system 100, 300 to enter into emergency mode of operation. For example, the system 100, 300 may be adapted to monitor power 722, and if external power is terminated, the system 100, 300 may use battery power for operation and automatically enter emergency mode. In another example, the system 100, 300 may be adapted to monitor seismic activity 724, and if integrated motion sensors 162, 362 measure significant motion (e.g., in the event of an explosion or earthquake), the system 100, 300 may enter emergency mode. In another example, the system 100, 300 may be adapted to monitor user input 726, and if the system 100, 300 has a wired or wireless external communication channel (e.g., Ethernet connection, wireless network connection, etc.), the system 100, 300 may be set into emergency mode by user command. For instance, the system 100, 300 may be adapted to monitor a wired or wireless network for emergency activity. For instance, at a location with multiple systems, one system entering emergency mode may trigger other systems in proximity to enter emergency mode so as to preserve video at the location from that time.

In one embodiment, referring to FIG. 7B, processing component 110, 310 may be adapted to operate and/or function as a emergency mode controller 730 adapted to detect an event (e.g., power failure event, seismic event, etc.) and set the system 100, 300 to operate in emergency mode (block 736). If the infrared imaging system 100, 300 detects an event and sets the system 100, 300 to operate in emergency mode (block 736), then an emergency mode state is set to true (block 732). Otherwise, if the infrared imaging system 100, 300 does not detect an event and does not set the system 100, 300 to operate in emergency mode (block 736), then an emergency mode state is set to false (block 734).

In one embodiment, referring to FIG. 7C, processing component 110, 310 may be adapted to operate and/or function as a locator signal controller 760 adapted to transmit a homing beacon signal to facilitate locating the system 100, 300, respectively, in a disastrous event (e.g., earthquake, fire, flood, explosion, building collapse, nuclear event, etc.). In one embodiment, if the system is in emergency mode (block 762) and/or a person is detected to be present (block 764), then a person present 766 is encoded as part of locator signal data 770 in a transmitted locator signal 772 (i.e., homing beacon signal). In one aspect, if more than one person was present, then the approximate number of persons present may be encoded as part of locator signal data 770 in the transmitted locator signal 772. Otherwise, in another embodiment, if the system is in emergency mode (block 762) and/or a person is not detected to be present (block 764), then a person not present 768 is encoded as part of locator signal data 770 in the transmitted locator signal 772.

In various embodiments, infrared imaging systems 100, 300 are adapted to operate as a disaster camera having a ruggedized enclosure for protecting the camera and non-volatile storage for infrared image data and information. The disaster camera, in accordance with embodiments, is adapted to sense various types of emergencies such as a flood, an earthquake and/or explosion (e.g., based on analysis of the thermal image data, via a built-in shock sensor, and/or seismic sensor), sense heat and smoke (e.g., from a fire based on the thermal image data or other sensors), and/or provide an ability to locate and count persons in a collapsed structure more easily. In one embodiment, the disaster camera may be adapted to operate in a black box mode utilizing a homing beacon signal (e.g., radio frequency (RF) signal) to find and locate after a disastrous event (e.g., building collapse, earthquake, explosion, etc.). For example, the disaster camera may be adapted to operate as a human presence enunciator for search and rescue events via the homing beacon signal. In one embodiment, the disaster camera includes a thermal camera, a seismic sensor, and an audible enunciator or RF transmitter that signals the presence of any detected persons in the event of seismic activity. Thermal camera imaging may detect the presence or absence of persons in a 360 degree field of view (FOV) by using multiple thermal image cameras or by scanning the FOV using one or more thermal image cameras. A seismic sensor is constantly monitoring for abrupt and abnormal sudden motion. When such a motion is sensed, an audible alarm may be voiced. The alarm is ruggedized and able to operate separately from the system, for example, as a warning beacon.

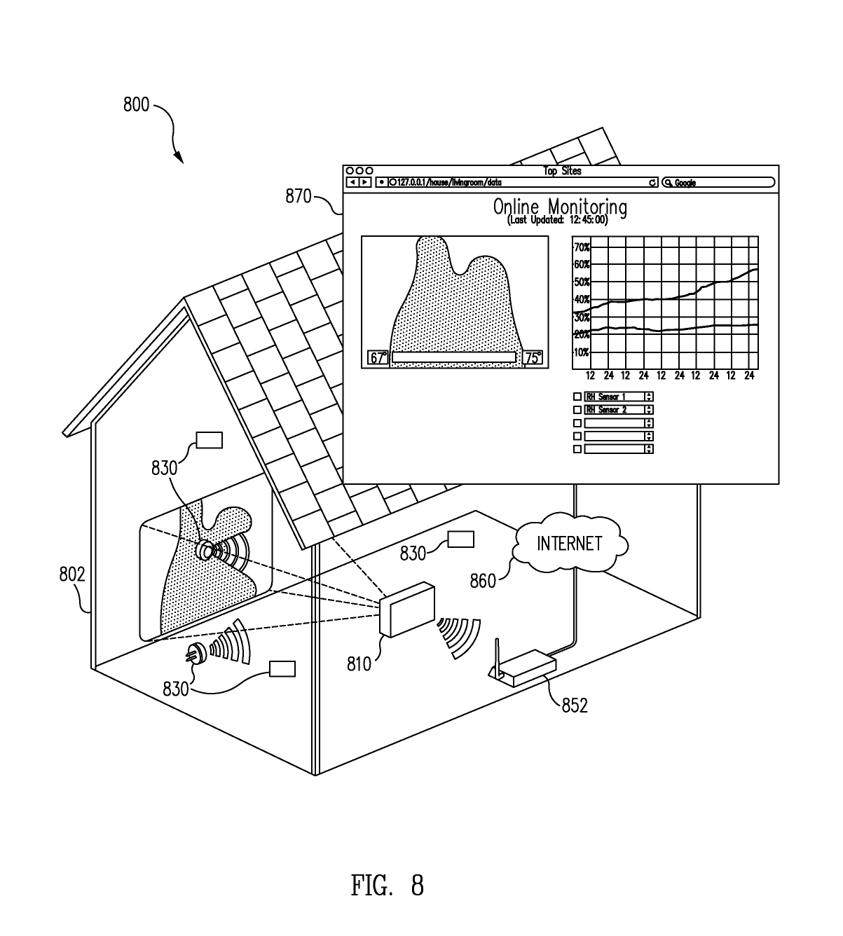

FIG. 8 shows an infrared imaging system 800 adapted for monitoring a structure, in accordance with one or more embodiments. For example, in one embodiment, infrared imaging system 800 may comprise a wireless thermal imaging system and/or a wireless thermal image monitoring system for disaster detection and/or disaster restoration monitoring of structure 802. In another embodiment, infrared imaging system 800 may comprise (or further comprise) a thermal imaging camera system for utilization as a disaster camera and/or workplace safety monitoring to aid first responders and/or detect fallen persons in structure 802. In one or more embodiments, infrared imaging system 800 of FIG. 8 may have similar scope and function of system 100 of FIG. 1 and/or infrared imaging system 300 of FIG. 3 and may operate as set forth herein (e.g., selectively in reference to FIGS. 1-7C).

In one or more embodiments, infrared imaging system 800 utilizes wireless multipoint monitoring devices 830 (e.g., thermal imaging devices, environmental sensor devices, etc.) to monitor the condition of structure 802 including measuring moisture, humidity, temperature, and/or ambient conditions and obtaining thermal images of its structural envelope and/or of its occupants. In one embodiment, condition data (e.g., information) may be collected locally via a processing component 810 and then sent to a hosted website 870 over a network 860 (e.g., Internet) via a network communication device 852 (e.g., a wired or wireless router and/or modem) for remote viewing, control, and/or analysis of restoration conditions and remediation progress. As such, infrared imaging system 800 may utilize network-enabled, multi-monitoring technology to collect a breadth of quality data and provide this data to a user in an easily accessible manner.

With respect to job monitoring and documentation perspectives, infrared imaging system 800 may improve the efficiency of capturing important moisture, humidity, temperature, and/or ambient readings within the structural envelope. Infrared imaging system 800 may be adapted to provide daily progress reports on restoration conditions and remediation progress at a jobsite for use by industry professionals, such as restoration contractors and insurance companies. Infrared imaging system 800 may be adapted to use moisture meters, thermometers, thermal imaging cameras, and/or hygrometers to monitor conditions and collect data associated with structure 802. Infrared imaging system 800 may be adapted to simultaneously monitor multiple locations at any distance. As such, remote monitoring of each location is useful, and infrared imaging system 800 effectively allows a user (e.g., operator or administrator) to continuously monitor structural conditions of multiple jobsites from one network-enabled computing device from anywhere in the world. Infrared imaging system 800 may provide real-time restoration monitoring that combines wireless sensing device networks and continuous visual monitoring of multiple environmental parameters including humidity, temperature, and/or moisture, along with thermal images and any other related parameters that influence the integrity of structures.

By coupling ambient sensor data with rich visual detail and thousands of thermal data points found in infrared images, infrared imaging system 800 may be versatile and valuable for structural monitoring, remediation, disaster detection, etc. Infrared imaging system 800 may significantly improve monitoring and documentation capabilities while providing time, travel, and cost savings over conventional approaches.

In one embodiment, infrared imaging system 800 with thermal imaging capabilities may be utilized for moisture monitoring, removal, and/or remediation in structure 802. Infrared imaging system 800 may be utilized for monitoring structures (e.g., residences, vacation homes, timeshares, hotels, condominiums, etc.) and aspects thereof including ruptured plumbing, dishwashers, washing machine hoses, overflowing toilets, sewage backup, open doors and/or windows, and anything else that may create the potential for moisture damage and/or energy loss. Commercial buildings may benefit from permanent installations of infrared imaging system 800 to provide continuous protection versus temporary ad-hoc installations.

In various aspects, infrared imaging system 800 may be utilized to expand structural diagnostic capabilities, provide real-time continuous monitoring, provide remote ability to set alarms and remote alerts for issues occurring on a jobsite, and improve documentation and archiving of stored reports, which for example may be useful for managing legal claims of mold damage. For example, infrared imaging system 800 may be used for restoration monitoring to provide initial measurements (e.g., of temperature, humidity, moisture, and thermal images) to determine initial conditions (e.g., how wet is the structure due to water damage) and may provide these measurements (e.g., periodically or continuously) to a remote location (e.g., hosted website or server) such that restoration progress may be monitored. The information (e.g., measurement data) provided may be used to view a time lapse sequence of the restoration to clearly show the progress of the remediation (e.g., how wet was the structure initially and how dry is it now or at completion of the remediation effort). The information may also be monitored to determine when the remediation is complete based on certain measurement thresholds (e.g., the structure is sufficiently dry and a completion alert provided) and to determine if an alert (e.g., alarm) should be provided if sufficient remediation progress is not being made (e.g., based on certain temperature, humidity, or moisture value thresholds).

Infrared imaging system 800 may be utilized to reduce site visit travel and expense by providing cost-effective remote monitoring of structures and buildings. Infrared imaging system 800 may be utilized to provide the contractor with quick and accurate validations that a jobsite is dry prior to removing drying equipment. Infrared imaging system 800 may be utilized to provide insurance companies and adjusters with access to current or past claims to monitor progress of a contractor, which may allow insurance companies to make sure the contractor is not charging for more work than is actually being performed, and allow insurance companies access to stored data for any legal issues that may arise.

Infrared system 800, for an embodiment, may be utilized to provide remote monitoring of structure 802 to detect a fire, flood, earthquake or other disaster and provide an alarm (e.g., an audible alarm, an email alert, a text message, and/or any other desired form of communication for a desired warning) to notify appropriate personnel and/or systems. For example for an embodiment, infrared system 800 may be distributed through a portion of or throughout a building to detect a fire or, for a recently extinguished fire, to detect if structural temperatures are beginning to increase or the potential risk for the fire to restart (e.g., to rekindle) is increasing and reaches a certain threshold (e.g., a predetermined temperature threshold). In such an application, infrared system 800 may provide an alarm to notify the fire department, occupants within structure 802, or other desired personnel. As a specific example for an embodiment, infrared system 800 may comprise one or more thermal infrared cameras (e.g., infrared imaging system 100, 300, or some portion of this system) within and/or around structure 802 to monitor for fire or potential rekindle potential of an extinguished fire. The thermal infrared cameras may provide thermal image data, which could be provided (e.g., sent via a wired or wireless communication link) to a fire station for personnel to monitor to detect a fire or potential of a fire (e.g., based on images and temperature readings of surfaces of structure 802). Infrared system 800 may also provide an alarm if certain thermal conditions based on the temperature measurements are determined to be present for structure 802.

In an embodiment, infrared imaging system 800 may include a base unit (e.g., processing component 810 and network communication device 852) that functions as a receiver for all wireless remote probes. The base unit may include a color display and be adapted to record data, process data, and transmit data (e.g., in real time) to a hosted website for remote viewing and retrieval by a user, such as a contractor, emergency personnel, and/or insurance appraiser. The base unit may include a touch screen display for improved usability and a USB and/or SD card slot for transferring data onsite without the use of a laptop or PC.

In one embodiment, infrared imaging system 800 may include various monitoring devices 830 (e.g., various types of sensors), which may include for example a first type of sensor and/or a second type of sensor. For example, the first type of sensor may include a pin-type moisture and ambient probe adapted to collect moisture levels and RH, air temperature, dew point, and/or grains per pound levels. Each first type of sensor may be uniquely identified based on a particular layout and/or configuration of a jobsite. As another example, the second type of sensor may represent a standalone thermal imaging sensor to capture infrared image data. As a specific example, the second type of sensor may include a display and may further include an integrated ambient sensor to monitor humidity and/or moisture levels. In one or more embodiments, the first and second type of sensors may be combined to form one modular sensor that may be compact, portable, self contained, and/or wireless and which may be installed (e.g., attached to a wall, floor, and/or ceiling) within a structure as desired by a user.

Infrared imaging system 800 may include an Internet connection adapted to transmit data from the base unit (e.g., network communication device 852) located at a jobsite in real-time via the Internet to a website for monitoring, analysis, and downloading. This may be achieved by a LAN/WAN at the site if one is available, or may require an internal wireless telecommunication system, such as a cellular-based (e.g., 3G or 4G) wireless connection for continuous data transmission.

In various embodiments, infrared imaging system 800 may include various monitoring devices 830, which may include for example moisture sensors and thermal imaging sensors fixed to a wall, baseboard, cabinet, etc. where damage may not occur and/or where a wide field of view of a given wall or surface may be achieved. Each monitoring device 830 (e.g., each sensor) may use a battery (e.g., a lithium battery) and, therefore, not require an external power source. Alternately, fixed, rotating sensors mounted on a ceiling may be employed to provide a 360 degree view of a given room. After installation of the base unit and sensors, any related software may be loaded onto a laptop, or use of a full-featured website may allow the user to configure reporting intervals and determine thresholds, and/or set readings desired for remote viewing. Configuration may be done onsite or remotely and settings may be changed at any time from the website interface, as would be understood by one skilled in the art.

Alarms may be configured to remotely notify the user of any problems that arise on a jobsite or other area being monitored by infrared imaging system 800. This may be achieved on the website by setting threshold alarms with specific moisture, humidity, or temperature ranges. For example, in some restoration cases, homeowners may unplug drying equipment at night because of excessive noise levels or, as another example, a contractor may load a single circuit with several drying devices that results in a fuse blowing when the homeowner switches additional electrical appliances on. With the alarm notification feature, the sensor automatically responds to a preset threshold and sends an email or text message to the user. For example, a user may set up the system to be notified if the relative humidity rises or air temperature falls (e.g., for water damage restoration applications), indicating a problem and meriting a visit by the contractor.

Infrared imaging system 800 may be secured with login credentials, such as a user identification and password permitting access to only certain persons. A user may choose to grant access to an insurance adjuster by providing a unique user name and password. Real time data may be automatically downloaded and stored to a server for future viewing. Even if there is a power failure at the jobsite, infrared imaging system 800 and/or the website may be adapted to store the captured data.

In one embodiment, with the data readings compiled and thermal images captured by infrared imaging system 800, a user may determine which areas need additional monitoring (e.g., drying or show proof that a building is completely dry) before leaving a jobsite. Data and records from the infrared imaging system 800 may be useful for mitigating legal exposure.

The monitoring devices 830 may include one or more ambient sensors with accuracy of at least +/−2% for relative humidity, with a full range of 0-100%, and a high temperature range up to a least 175° F., as specific examples. The monitoring devices 830 may include one or more moisture sensors with a measuring depth, for example, up to at least 0.75″ into building material. The monitoring devices 830 may include one or more thermal views from one or more thermal cameras providing one or more wall shots or 360-degree rotational views. The monitoring devices 830 may include a long range wireless transmission capability up to, for example, 500 feet between each monitoring device 830 and the base unit (e.g., processing component 810 and network communication device 852, which may be combined and/or implemented as one or more devices). The base unit may be accessible via a wired and/or wireless network and may provide 24/7 data availability via dynamic online reporting tools adapted to view, print, and email charts and graphs of the monitoring conditions, as would be understood by one skilled in the art. Infrared imaging system 800 may provide for full access to system configuration settings, customizable thresholds and alarms, user access management (e.g., add, remove, and/or modify personnel access), and alerts the user or operator via cell phone, text message, email, etc., as would be understood by one skilled in the art. Infrared imaging system 800 may include a display to view real time readings on site and provide the ability to toggle between room sensors.

In one embodiment, conventional visible light cameras (e.g., visible spectrum imagers) are typically not accepted in areas were privacy is protected, such as bathrooms, showers, etc. In contrast, an infrared imager (e.g., a low resolution thermal imager) provides a thermal image where the identity of a person may be protected because the person appears as a warm blob that does not represent detailed features, such as facial features, of a person. As such, an infrared imager may be selected or designed to provide low resolution thermal images that define a person as a non-descript blob to protect the identity of the person. Thus, infrared imagers are less intrusive than visible light imagers. Furthermore, due to the radiometric capabilities of thermal imagers, objects at human temperature ranges may be discriminated from other objects, which may allow infrared imaging systems and methods in accordance with present embodiments to operate at a low spatial resolution to detect persons, without producing images that may allow for observers to determine the identity of the persons.

Where applicable, various embodiments of the invention may be implemented using hardware, software, or various combinations of hardware and software. Where applicable, various hardware components and/or software components set forth herein may be combined into composite components comprising software, hardware, and/or both without departing from the scope and functionality of the present disclosure. Where applicable, various hardware components and/or software components set forth herein may be separated into subcomponents having software, hardware, and/or both without departing from the scope and functionality of the present disclosure. Where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, ordering of various steps described herein may be changed, combined into composite steps, and/or separated into sub-steps to provide features described herein.

In various embodiments, software for modules 112A-112N may be embedded (i.e., hard-coded) in processing component 110 or stored on memory component 120 for access and execution by processing component 110. In one aspect, code (e.g., software and/or embedded hardware) for modules 112A-112N may be adapted to define preset display functions that allow processing component 100 to automatically switch between various processing techniques for sensed modes of operation, as described herein.

Embodiments described above illustrate but do not limit the disclosure. It should also be understood that numerous modifications and variations are possible in accordance with the principles of the present disclosure. Accordingly, the scope of the disclosure is defined only by the following claims.

What is claimed is:

1. A wireless thermal imaging system, comprising:
a communication component adapted to remotely communicate with a user over a network;
one or more wireless thermal image sensors adapted to capture and provide thermal images of structural objects of a structure for monitoring moisture and/or temperature of the structural objects; and
a processing component adapted to receive the thermal images of the structural objects from the one or more wireless thermal image sensors, and process the thermal images of the structural objects to generate at least one of moisture content information for remote analysis of restoration conditions of the structural objects and/or fire hazard information for remote analysis of fire hazard conditions for the structural objects.

2. The system of claim 1, wherein the one or more wireless thermal image sensors comprise one or more infrared cameras adapted to continuously monitor environmental parameters including one or more of humidity, temperature, and moisture associated with the structural objects.

3. The system of claim 1, wherein the wireless thermal imaging system comprises a ruggedized thermal camera system adapted for use as a disaster monitoring camera system to detect and monitor damage from disastrous events including at least one of flooding, fire, explosion, and earthquake, and wherein the ruggedized thermal camera system comprises an enclosure to enclose each of the corresponding thermal image sensors and is configured to withstand disastrous events.

4. The system of claim 1, wherein the wireless thermal imaging system comprises a thermal camera system adapted for use as a safety monitoring system to detect one or more persons in the structure including one or more fallen persons in the structure, and wherein the processing component is adapted to generate an alert to emergency personnel in the event of a fire or a person in need of assistance.

5. The system of claim 1, wherein the one or more wireless thermal image sensors are adapted to monitor one more conditions of the structure including measuring one or more of moisture, humidity, and ambient conditions of its structural envelope.

6. The system of claim 1, wherein condition information of the structural objects of the structure is collected locally via the processing component and provided to a hosted website over the network via the communication component for remote viewing and analysis of restoration conditions by the user.

7. The system of claim 1, further comprising wireless sensors including a moisture meter and/or a hygrometer to monitor moisture conditions and provide information on the moisture conditions related to the structure to the processing component.

8. The system of claim 1, wherein the infrared imaging system is adapted to simultaneously monitor multiple structures.

9. The system of claim 1, wherein the one or more wireless thermal image sensors are affixed to at least one structural object of the structure to provide a view of one or more other structural objects of the structure to monitor the temperature of the structural objects to provide the fire hazard information for the remote analysis afire hazard conditions for the structural objects, and wherein the processing component is adapted to provide an alarm to notify authorities if a fire hazard reaches a predetermined threshold based on the temperature.

10. The system of claim 1, wherein the processing component is adapted to provide an alarm to remotely notify the user of a disastrous event related to the structure based on a threshold condition with specific moisture or temperature ranges.

11. A method, comprising:
remotely communicating with a user over a network;
capturing and providing thermal images of structural objects of a structure for monitoring moisture and/or temperature levels of the structural objects;
receiving the thermal images of the structural objects from one or more wireless thermal image sensors; and
processing the thermal images of the structural objects to generate at least one of moisture content information for remote analysis of restoration conditions of the structural objects and/or fire hazard information for remote analysis of fire hazard conditions for the structural objects.

12. The method of claim 11, further comprising monitoring environmental parameters of the structural objects including one or more of humidity, temperature, and moisture associated with the structural objects.

13. The method of claim 11, further comprising:
detecting and monitoring damage from disastrous events including at least one of flooding, fire, explosion, and earthquake; and
generating an alert to provide information based on the detecting and monitoring to authorities.

14. The method of claim 11, further comprising:
detecting one or more persons in the structure including one or more fallen persons in the structure; and
communicating with authorities to provide information based on the processing and/or the detecting.

15. The method of claim 11, further comprising monitoring one more conditions of the structure including measuring one or more of moisture, humidity, temperature, and ambient conditions of its structural envelope.

16. The method of claim 11, further comprising:
gathering condition information of the structural objects of the structure; and
sending the condition information to a hosted website over the network for remote viewing and analysis of restoration conditions by the user.

17. The method of claim 11, further comprising storing the thermal images and/or moisture content information in a memory component.

18. The method of claim 11, wherein the method is adapted to simultaneously monitor multiple structures.

19. The method of claim 11, further comprising providing an alarm to remotely notify the user of a disastrous event related to the structure based on a threshold condition with specific moisture or temperature ranges.

20. A computer-readable medium on which is stored non-transitory information for performing a method by a computer, the method comprising:
remotely communicating with a user over a network;
receiving thermal images of structural objects of a structure from one or more wireless thermal image sensors; and
processing the thermal images of the structural objects to generate moisture content information for remote analysis of restoration conditions of the structural objects and/or fire hazard information for remote analysis of fire hazard conditions for the structural objects.
